(19) United States
(12) Patent Application Publication
(10) Pub. No.: US 2010/0106868 A1
(43) Pub. Date: Apr. 29, 2010

(54) Mobile music station

(76) Inventor: Ryan Andrew Lame, Tucson, AZ (US)

Correspondence Address: THE INVENTORS NETWORK, INC., 332 ACADEMY STREET, CARNEGIE, PA, 15106, US

(21) Appl. No.: 12/288,691

(22) Filed: Oct. 23, 2008

(51) Int. Cl. G06F 13/20

(52) U.S. Cl. 710/33

(57) ABSTRACT

A mobile music station for downloading ring tones and music selections from various file storage sources to an individual's cell phone or MP 3 player includes a cpu interconnected to several discrete file storage sites having either a wide range of ring tones and music selections stored therein and accessed by connecting the individual's cell phone or MP 3 player to the appropriate data cable mounted on the front side of the station by following prompts on a user-friendly browsing screen also located on the front side of the station with the station also including a CD-DVD drive for editing and downloading songs and selections from a user provided CD or DVD, and a payment card reader disposed on the front side of the station for reading the individual's credit card or ATM card so that payment can be made after song and/or ring tone selection and prior to downloading and transfer to the individual's consumer device.

### FIELD OF THE INVENTION

The present invention pertains to digital music data transfer from a host to a target, and more particularly pertains to a system for downloading music selections and customized ring tones selected from diverse sources to MP3 players and cellular telephones.

### BACKGROUND OF THE INVENTION

The technological advances in microelectronics and telecommunications have fundamentally altered the way people obtain, organize, listen to, and transfer recorded music pieces, songs, and selections. Music is now obtained, stored, organized, and transferred as compressed digital files. The technological revolution in microelectronics and telecommunications has transformed music into a commodity that can be bought and sold like any other consumer product, item, or commodity.

One of the most common ways to obtain music selections for storage and play on consumer devices such as cellular telephones and MP 3 players is by purchasing such selections from a remote source or vehicle. In addition, a sub industry has grown up around what are referred to as “ring tone downloads” which are brief excerpts of music songs and selections ranging from classical to contemporary, and which are downloaded and stored on one's cell phone as the personalized ring tone for that cell phone. Music selections and song downloads, and ring tones, can be purchased from numerous Internet-based sites and downloaded as discrete files to one's home computer; or an individual can use his or her cell phone's GPRS to access an Internet site for obtaining and downloading music songs and selections including ring tones.

One prerequisite and problem with the first alternative is that one must own a computer and expensive data cables to download material and transfer data to one's consumer device. The major disadvantage with using the GPRS on the individual's cell phone is that access and download of music selections and other data can be a slow process and the music download selections can be very limited. Thus, a broader, more accessible and usable system or process of downloading is desired, especially given the fact that there are currently around 170 million cellular telephone users in the United States alone, and many of these cell phone (and MP 3 owners) are not technologically savvy.

Thus, the prior art discloses a variety of systems and methods to access, transfer, distribute, and store music and musical files from one medium to another or between media.

For example, the Sai et al. patent (U.S. Pat. No. 5,691,494) discloses a centralized system providing karaoke service and extraneous service to terminals that includes a Karaoke apparatus, a host apparatus, and a management apparatus all of which are interconnected.

The Schlossberg patent (U.S. Pat. No. 6,324,378 B1) discloses an interactive learning center that includes a series of multi-media interactive booths grouped in stations wherein hand-held control boxes that are carried by students access musical compositions stored at each station.

The Nobumoto patent (U.S. Pat. No. 6,437,229 B1) discloses equipment and process for music digitalization storage, access, and listening that includes at least one digital music server, a music digitalizing station, and at least one listening station all of which are interconnected in a network.

The Tonet patent (U.S. patent publication no. US 2004/0221709 A1) discloses a music machine that includes a plurality of computers interconnected to a central server (a remote computer) by any conventional means and through which music from a music box is played but not filed on the hard drives of the computers.

The Eck et al. patent (U.S. Pat. No. 6,884,171 B2) discloses a video game distribution network for use in a wide variety of situations wherein special purpose game binary image files are distributed to a general-purpose computing/display device.

The Fein patent (U.S. patent publication no. US 2005/0125355 A1) discloses a digital media creator-destroyer apparatus for receiving and storing digital media, for generating transferable copies, and for destroying unused copies.

Nonetheless, despite the ingenuity of the above systems and devices, there remains a need for an easy-to-access and easy-to-use device for downloading a wide range of music selections and personalized and customized ring tones onto one's cell phone and/or MP 3 player.

### SUMMARY OF THE INVENTION

The present invention comprehends a mobile music download station for allowing one or more individuals to access and transfer musical selections and musical ring tones from a variety of sources onto their personal consumer devices, primarily their cell phones and/or MP 3 players. The mobile music station of the present invention allows the consumer to save time and money by using music accessing, editing, and transferring processes integral with the station to personalize and customize the ring tones for their consumer devices, such as their cell phones, and for downloading music selections to their MP 3 players.

The mobile music station of the present invention includes a kiosk or download station that can be located in any desired outlet such as a shopping mall or convenience store, and the download station includes a base and a front side. Located on the front side is an interactive user friendly browsing screen that allows the user to select the type of music download source (ring tone, MP 3, or user provided CD) from the appropriate file storage site, the type of data cable compatible with the particular download target (cell phone or MP 3 player), and the actual musical selection or ring tone selection to be transferred to the individual's particular consumer device. The mobile music station includes a CD-ROM/DVD-ROM drive for receiving and playing a user provided CD or DVD, and a payment card reader for registering payment of the downloaded selections.

A plurality of data cables are mounted to the front side of the station below the browsing screen and are interconnected to a cpu housed within the station, and each data cable is dedicated to and compatible with a specific make and model of cell phone and MP 3 player. After the appropriate data cable is determined, and the type of download is selected, the individual uses the browsing screen to scroll through a very large list or range of selections for personalizing and customizing his or her cell phone ring tone and for obtaining music selection downloads for his or her MP 3 player.

It is an objective of the present invention to provide a mobile music download station for transferring music from a variety of file storage sites and sources to one or more cell phones.

It is another objective of the present invention to provide a mobile music download station that allows an individual to transfer ring tones from file storage sites or sources onto the individual's cell phone for producing a customized cell phone ring tone.

It is still another objective of the present invention to provide a mobile music download station that is a fun and convenient way to customize and personalize one's cell phone ring tone.

It is yet another objective of the present invention to provide a mobile music download station that eliminates the need to search the Internet for customized ring tones, and eliminates the need to pay for individual ring tones.

It is still yet another objective of the present invention to provide a mobile music download station that simplifies and eases the task of finding the desired ring tone to customize and personalize one's cell phone.

Still another objective of the present invention is to provide a mobile music download station that eliminates the need to purchase a personal computer and expensive data cables as a prerequisite for downloading music songs and selections and personalized ring tones.

These and other objects, features, and advantages will become apparent to those skilled in the art upon a perusal of the following detailed description read in conjunction with the accompanying drawing figures and appended claims.

### BRIEF DESCRIPTION OF THE DRAWINGS

FIG. 1 is a perspective view of the mobile music download station of the present invention illustrating the primary interactive features presented to the individual for initiating, processing, and completing one or more music song and/or ring tone downloads and transfers;

FIG. 2 is an enlarged perspective view of the mobile music download station of the present invention illustrating the plurality of data cables available for connection to the particular make and model of the cell phone and/or MP3 player;

FIG. 3 is a front elevational view of the mobile music download station of the present invention illustrating the layout of the screen that allows the individual to select the type of download to be performed;

FIG. 4 is a front elevational view of the mobile music download station of the present invention illustrating the layout of the screen that allows the individual to select a music ring tone selection corresponding to and compatible with the make and model of the cell phone of the individual;

FIG. 5 is a front elevational view of the mobile music download station of the present invention illustrating the layout of the screen that allows the individual to select a music song from the MP 3 file storage library and transfer that music song to the individual's MP 3 player;

FIG. 6 is a front elevational view of the mobile music download station of the present invention illustrating the layout of the screen that allows the individual to select a music song from a user provided CD for transference to the cell phone and/or the MP 3 player of the individual;

FIG. 7 is a schematic view of the mobile music download station of the present invention illustrating the primary internal structural components;

FIG. 8 is a flowchart of the mobile music download station of the present invention illustrating the sequence of steps the individual must follow in order to select, download, pay for and transfer one or more music songs or ring tones to their particular consumer device, be it a cell phone or MP 3 player;

FIG. 9 is a front elevational view of the mobile music station of the present invention illustrating a representative user provided CD that can be inserted into the station and from which songs and music selections can be selected, edited and transferred to the desired consumer electronic device; and

FIG. 10 is a front elevational view of the mobile music station of the present invention illustrating a representative user provided DVD that can be inserted into the station and from which songs and music selections can be selected, edited, and transferred to the desired consumer electronic device.

### DETAILED DESCRIPTION OF THE PREFERRED EMBODIMENT

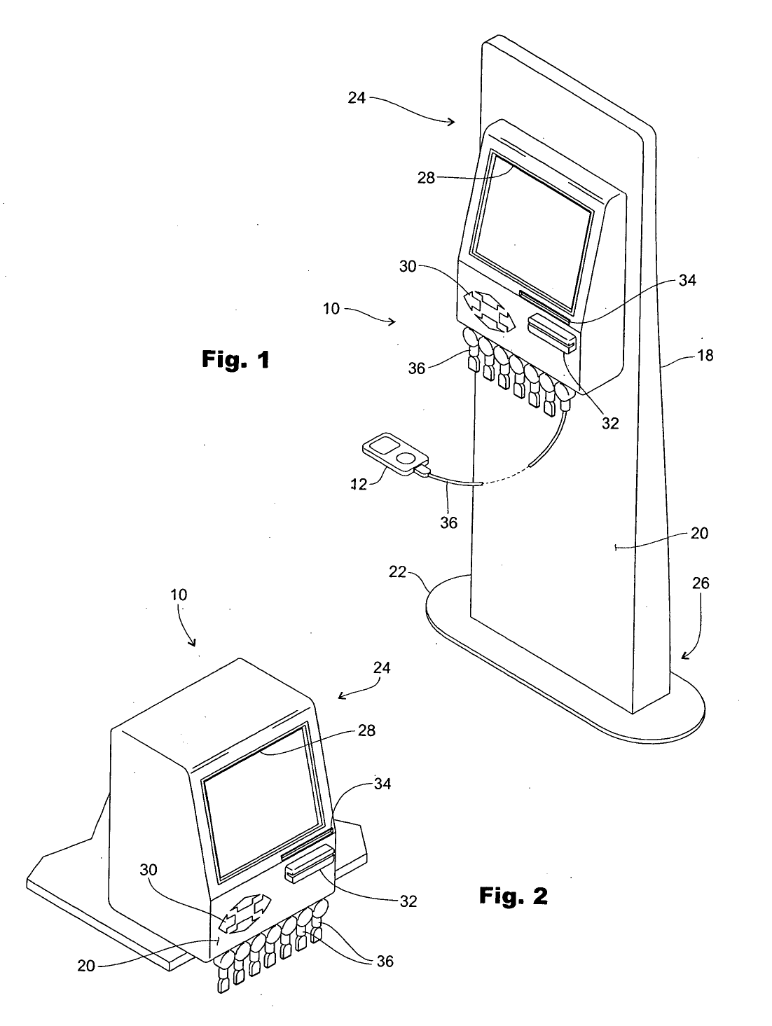

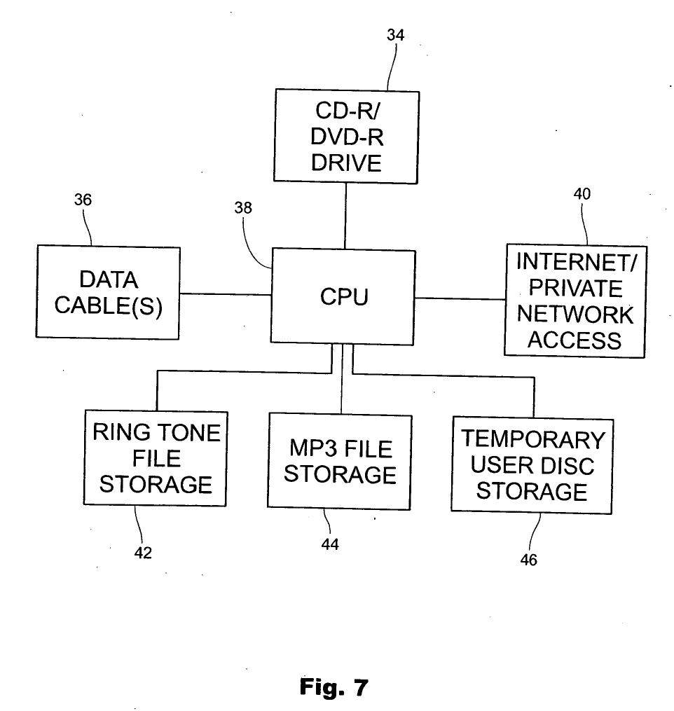

Illustrated in FIGS. 1-10 is a mobile music station 10 that allows the user or individual the capability to download and transfer ring tones and musical songs onto his or her particular consumer electronic device 12, primarily a cellular (cell) telephone or MP 3 player from a variety of sources. The sources can include a ring tone library; MP 3 full song library and songs derived from a user supplied CD 14 or DVD 16. The mobile music station 10 of the present invention thus provides the individual with a very wide range of ring tones and music songs to download and transfer to their cell phone and/or MP 3 player, and eliminates the need to search the Internet or pay for individual ring tones. Thus, the user can personalize and customize his or her cell phone by downloading the desired ring tone, and can increase the range and variety of song selections stored on his or her MP 3 player.

Thus, illustrated in FIGS. 1-10 is a kiosk or station 18 having a front side 20 and a base 22. The station 18 further defines an upper end 24 and a lower end 26. Located on the front side 20 is a user-friendly browsing screen 28 on which appear the various screen prompts and displays that the user follows for accessing, searching, selecting, and transferring ring tones and songs onto the consumer electronic device 12 of choice, i.e., the cell phone or MP 3 player. Located immediately beneath the browsing screen 28 is a selection pad 30 that the individual manually presses to navigate between and among the various screen displays that can be brought up on the browsing screen 28. Also located immediately beneath the browsing screen 28 is a payment card reader 32 through which a credit card or ATM card is swiped for making payment to the mobile music station provider after all the ring tones and music selections have been made.

As shown in FIGS. 1-3, 9, and 10, the mobile music station 10 also includes a CD-ROM/DVD-ROM drive 34 for the insertion therein of the user provided CD 14 or DVD 16. The user provided CD 14 or DVD 16 can contain ring tones and songs prepared by the individual, friends, a local musical band, etc., and which can be edited and then downloaded and transferred as desired to the particular consumer electronic device 12. Also, as shown in FIGS. 1-3, a plurality of data cables 36 are mounted on the front side 20, and each data cable 36 is dedicated for making the connection or attachment to a specific make and model of cell phone or MP 3 player. The mobile music station 10 has the capability to expand and accommodate additional ports and data cables.

The mobile music station 10 includes internal electronic and computer circuitry that is interconnected to and operates the above features—the browsing screen 28, the selection pad 30, the payment card reader 32, the CD-ROM/DVD-ROM drive 34, and the data cables 36 (with the appropriate cell phone and/or MP 3 player connected thereto). Thus, the mobile music station 10 includes an internal cpu 38 interconnected to the data cables 36, the browsing screen 28, the payment card reader 32, and the CD/DVD drive 34. In addition, an Internet private network access line or connection 40 can be made to the cpu 38 for further updating and expanding the range and variety of ring tones and music song selections. A primary component of the internal hardware and software are the file storage areas for the various types of download(s) to be made to the particular cell phone or MP 3 player. Thus, interconnected to the cpu 38 is ring tone file storage section 42 wherein the range and variety of ring tone selections are stored, an MP 3 file storage section 44 wherein the range and variety of MP 3 full song selections are stored, and a temporary user disc storage section 46 which serves as a temporary storage location when the user provides his or her own CD 14 or DVD 16.

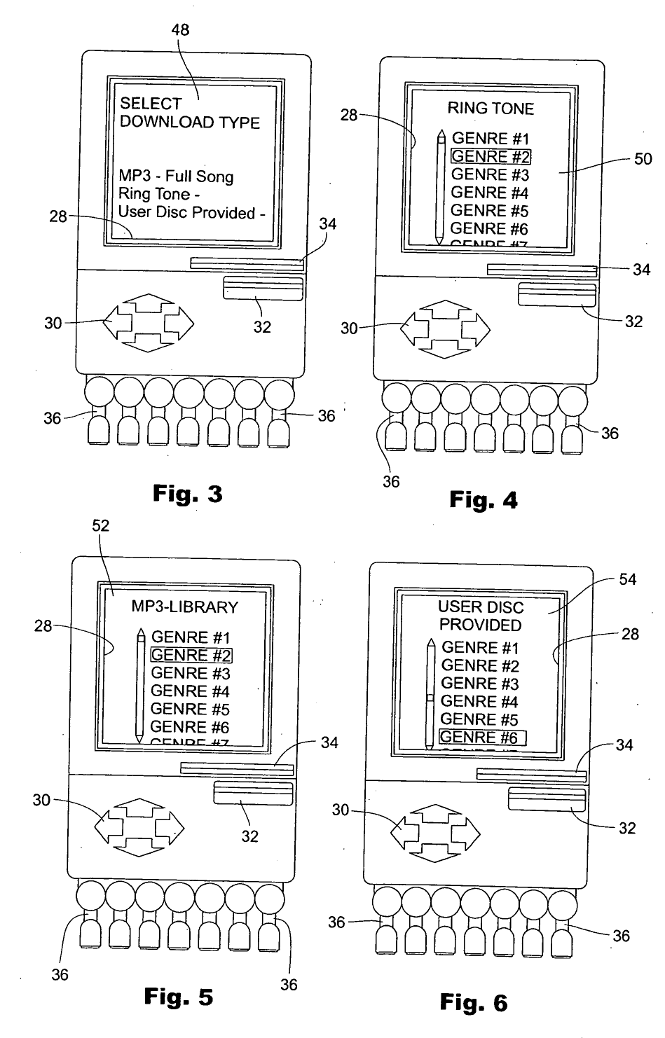

FIGS. 3-6 illustrate representative screen displays that appear on the browsing screen 28 for guiding the individual through the steps of selecting, downloading and transferring ring tones and music songs to the desired consumer electronic device 12. FIG. 3 illustrates an initial display selection screen 48 that allows the user to select the type of download: an MP 3 full song download, a ring tone download, or a download from a user provided CD 14 or DVD 16 disc. FIG. 4 illustrates a representative ring tone display screen 50 that appears when the ring tone download is selected. A wide list or selection of ring tones generically labeled genre #1 etc. appear for selection and download by the user to his or her consumer electronic device 12. FIG. 5 illustrates a representative MP 3 library screen 52 that is displayed when the MP 3 full song download is selected. A wide range of MP 3 full songs, generically labeled genre #1, etc. appear for selection and download by the user to the individual's MP 3 player. FIG. 6 illustrates a representative user screen display 54 that appears when the user chooses the user provided CD/DVD download selection. The music selections found on the CD 14 or DVD 16 and stored in the temporary user disc storage section 46 for editing and download therefrom are generically labeled genre's #1 etc.

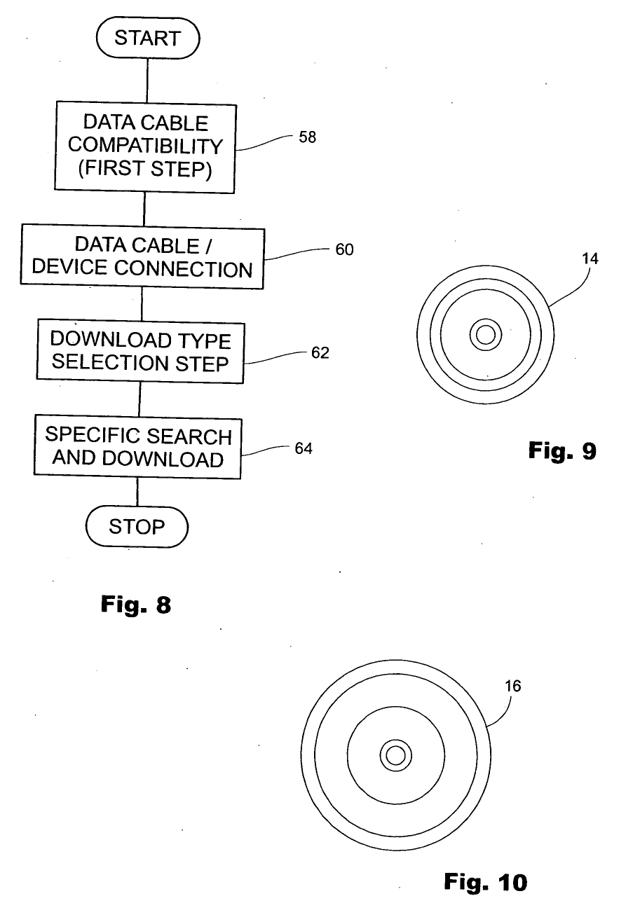

Illustrated in FIG. 8 is a representative flowchart 56 setting forth the sequence of steps the individual undertakes when using the mobile music station 10 to transfer and download ring tones and/or music songs to the desired consumer electronic device 12. Thus, the first step 58 is to select the appropriate data cable 36 that is compatible with the particular consumer electronic device 12 based upon the specific make and model or model number of the cell phone or MP 3 player. The browsing screen 28 will then display the appropriate data cable 36 (or USB), and the user then connects his/her consumer electronic device 12 to that data cable 36, the device connection step 60. The user would then use the selection pad 30 by bringing up the initial screen display 48 as aforedescribed and shown in FIG. 3. The user would then select in this download selection step 62 the type of download (ring tone, MP 3 full song, or user provided CD/DVD) he or she desires to make. If the user selects the user provided CD/DVD or selection, the user would then need to insert the CD 14 or DVD 16 in the CD/DVD drive 34 for initiating the transfer, selection and downloading of the desired song or songs from the CD 14 or DVD 16. With the type of download selected, the user would then bring up one of the three screen displays 50, 52, or 54, as shown in FIGS. 4-6, that follows from the type of download selected in order to commence the selection specific download step 64 to search for and then download the desired song (to the individual's MP 3 player) or personalized ring tone for customizing and personalizing one's cell phone ring tone. The user also has the ability through the selection pad 30 to edit music on the user provided CD 14 or DVD 16 that has been previously inserted into the CD/DVD drive 34. Finally, after the user has selected the specific ring tone or song from the specific file storage section 42, 44, or 46, and has downloaded and transferred the selections, payment is made of the user's download purchases via the payment card reader 32.

While the present invention has been disclosed with respect to the described and illustrated embodiments, it is to be understood that the invention is not to be limited to those embodiments. Accordingly, reference should be made primarily to the following claims rather than the foregoing description to determine the scope of the invention.

I claim:

1. A mobile music station for downloading ring tones onto a cell phone, comprising:
an upright station having a front side, an upper end, a lower end, and a base;
a browsing screen mounted on the front side and whereon a plurality of screen displays can be successively brought up that guide the individual through the procedure for downloading ring tones onto the cell phone;
a selection pad mounted on the front side and which is manually pressed by the individual for initiating and completing the downloading of ring tones to the cell phone;
a payment card reader mounted on the front side for registering payment by the individual for the ring tone downloads;
a CD/DVD drive mounted to the front side for receiving and reading a CD and a DVD;
a plurality of data cables mounted on the front side and each data cable being dedicated to attachment to one specific make and model of cell phone for successfully downloading ring tones thereto;
a cpu encased within the station and interconnected to the browsing screen, the selection pad, the payment card reader, the CD/DVD drive, and the data cables for controlling their operations;
a ring tone file storage section interconnected to the cpu and having stored therein a plurality of cell phone ring tones;
an MP 3 full song file storage section interconnected to the cpu and having stored therein a plurality of full songs downloadable to the MP 3 player;
a temporary user disc storage section interconnected to the cpu for temporary storage therein of songs from the CD and DVD that are to be downloaded to the MP 3 player and the cell phone; and
wherein the individual uses the selection pad for bringing up the succession of screen displays on the browsing screen so that the appropriate data cable is connected to the cell phone and whereupon the desired ring tone is selected from the ring tone file storage section and then transferred and downloaded to the cell phone thereby allowing the individual to personalize and customize the ring tone of the individual's cell phone.

2. A mobile music station for downloading full songs onto an MP 3 player, comprising:
an upright station having a front side, an upper side, a lower end, and a base;
a browsing screen mounted on the front side and whereon a plurality of screen displays can be successively brought up that guide the individual through the procedure for downloading full songs to the MP 3 player;
a selection pad mounted on the front side and which is manually pressed by the individual for initiating and completing the downloading of full songs to the MP 3 player;
a payment card reader mounted on the front side for registering payment by the individual for the full song downloads;
a CD/DVD drive mounted at the front side for receiving and reading a CD and a DVD;
a plurality of data cables mounted on the front side and each data cable being dedicated to attachment to one specific make and model of MP 3 player for successfully downloading full songs thereto;
a cpu contained within the station and interconnected to the browsing screen, the selection pad, the payment card reader, the CD/DVD drive, and the data cables for controlling their operations;
a ring tone file storage section interconnected to the cpu and having stored therein a plurality of cell phone ring tones;
an MP 3 full song file storage section interconnected to the cpu and having stored therein a plurality of full songs that are downloadable to the MP 3 player;
a temporary user disc storage section interconnected to the cpu for temporary storage therein of songs from the CD and the DVD that are to be selected and downloaded to the MP 3 player; and
wherein the individual uses the selection pad for bringing up the succession of screen displays on the browsing screen so that the appropriate data cable is connected to the MP 3 player and whereupon the desired full song is selected from the MP 3 file storage section and then transferred and downloaded to the individual's MP 3 player.

3. A mobile music station for downloading musical songs from a CD and a DVD onto a cell phone and an MP 3 player, comprising:
an upright station having a front side, an upper end, a lower end, and a base;
a browsing screen mounted on the front side and whereon a plurality of screen displays are successively brought up that guide the individual through the procedure for downloading music songs from the CD and DVD onto the cell phone and MP 3 player;
a selection pad mounted on the front side and which is manually pressed by the individual for initiating and completing the downloading of music songs from the CD and DVD;
a payment card reader mounted to the front side for registering payment by the individual for the music song downloads;
a CD/DVD drive mounted to the front side for receiving and reading the music songs contained on the CD and the DVD;
a plurality of data cables mounted on the front side and each data cable dedicated for attachment to a specific make and model of cell phone and MP 3 player for successfully downloading music songs thereto;
a cpu contained within the station and interconnected to the browsing screen, the selection pad, the payment card reader, the CD/DVD drive, and the data cables for controlling their operations;
a ring tone file storage section interconnected to the cpu and having stored therein a plurality of cell phone ring tones;
an MP 3 full song file storage section interconnected to the cpu and having stored therein a plurality of full songs downloadable to the MP 3 player;
a temporary user disc storage section interconnected to the cpu for temporary storage therein of music songs transferred from the CD and the DVD and that are to be downloaded to the MP 3 player and the cell phone; and
wherein the individual uses the selection pad for bringing up the succession of screen displays on the browsing screen so that the appropriate data cable is connected to the cell phone or the MP 3 player, and the CD or DVD is inserted into the CD/DVD reader for the selection and downloading of the desired music song.
